(19) United States
(12) Patent Application Publication
(10) Pub. No.: US 2014/0260802 A1
(43) Pub. Date: Sep. 18, 2014

(54) PROCESSING MINED MATERIAL

(71) Applicants: Samuel Kingman, Rolleston on Dove (GB); Georgios Dimitrakis, Nottingham (GB); Christopher Dodds, West Bridgford (GB); Grant Ashley Wellwood, Pheasant Creek (AU)

(72) Inventors: Samuel Kingman, Rolleston on Dove (GB); Georgios Dimitrakis, Nottingham (GB); Christopher Dodds, West Bridgford (GB); Grant Ashley Wellwood, Pheasant Creek (AU)

(73) Assignee: TECHNOLOGICAL RESOURCES PTY. LIMITED, Brisbane, QLD (AU)

(21) Appl. No.: 14/235,883

(22) PCT Filed: Aug. 3, 2012
(86) PCT No.: PCT/AU2012/000913

§ 371 Date: Apr. 8, 2014

(30) Foreign Application Priority Data
Aug. 3, 2011 (AU) 2011903079

(51) Int. Cl. C22B 1/00; B07C 5/34

(52) U.S. Cl. CPC C22B 1/00; B07C 5/34
USPC 75/392; 209/3.1

(57) ABSTRACT

An apparatus for processing mined material, such as mined ore, is disclosed. The apparatus includes an applicator (2) for exposing a downwardly moving bed of fragments of a material to electromagnetic radiation. The applicator includes a tube (4) for containing the moving bed of fragments that has an upper inlet and a lower outlet and a transverse cross-sectional area that increases between the inlet and the outlet.

### TECHNICAL FIELD

The present invention relates to a method and an apparatus for processing mined material.

The present invention also relates to an applicator for exposing fragments of mined material to electromagnetic radiation for use in the method and apparatus for processing mined material.

The term “mined” material is understood herein to include metalliferous material and non-metalliferous material. Iron-containing and copper-containing ores are examples of metalliferous material. Coal is an example of a non-metalliferous material. The term “mined” material is understood herein to include, but is not limited to, (a) run-of-mine material and (b) run-of-mine material that has been subjected to at least primary crushing or similar size reduction after the material has been mined and prior to being sorted. The mined material includes mined material that is in stockpiles.

The present invention relates particularly, although by no means exclusively, to a method and an apparatus for processing mined material to facilitate subsequent recovery of valuable material, such as valuable metals, from the mined material.

The present invention also relates to a method and an apparatus for recovering valuable material, such as valuable metals, from mined material that has been processed as described above.

The present invention relates particularly, although by no means exclusively, to a method and an apparatus for processing low grade mined material at high throughputs.

### BACKGROUND ART

The applicant is developing an automated sorting method and apparatus for mined material.

In general terms, the method of sorting mined material being developed by the applicant includes the following steps:

(a) exposing fragments of mined material to electromagnetic radiation,

(b) detecting and assessing fragments on the basis of composition (including grade) or texture or another characteristic of the fragments, and

(c) physically separating fragments based on the assessment in step (b).

Automated ore technology known to the applicant is limited to low throughput systems. The general approach used in these low throughput sorting systems is to convey ore fragments through sorters on a horizontal belt. While horizontal conveyor belts are a proven and effective approach for fragments greater than 10 mm at throughputs up to around 200 t/h, the conveyor belts are unable to cater for the larger throughputs 500-1000 t/h needed to realise the economies of scale required for many applications in the mining industry such as sorting low grade ore having particle sizes greater than 10 mm.

The applicant is also developing a method and an apparatus for forming microfractures in fragments of mined material by exposing the fragments to electromagnetic radiation. The microfractures in the fragments facilitate downstream processing of the fragments to recover valuable material, such as valuable metals, from the fragments. The downstream processing options include, by way of example, heap leaching, with the microfractures allowing leach liquor to penetrate the fragments and improve recovery of valuable metals. Another downstream processing option includes comminuting the fragments and forming smaller fragments, processing the smaller fragments in a flotation circuit and forming a concentrate and smelting the concentrate to recovery valuable metals. As is the case with ore sorting technology discussed above, the technology for forming microfractures in fragments of mined material known to the applicant is limited to low throughput systems.

An issue for the technology development paths of the applicant in the fields of sorting fragments and forming microfractures in fragments relates to processing mined material at high throughputs.

The above description is not to be understood as an admission of the common general knowledge in Australia or elsewhere.

### SUMMARY OF THE DISCLOSURE

In general terms, the present invention provides an apparatus for processing mined material, such as mined ore, that includes an applicator for exposing a downwardly moving bed of fragments of a material to electromagnetic radiation, the applicator including a tube for containing the moving bed of fragments that has an upper inlet and a lower outlet and a transverse cross-sectional area that increases between the inlet and the outlet.

The present invention is based on a realisation that providing the applicator tube with a transverse cross-sectional area that increases between the inlet and the outlet of the tube reduces:

(a) the friction between the moving bed of fragments and the tube, and

(b) the outward pressure applied by the moving bed to the tube.

The overall result of a reduction in frictional forces/drag assists in making it possible to operate under plug flow conditions, i.e. with uniform movement of fragments down the tube with the uniform movement being across the transverse cross-section of the tube. Plug flow is a desirable form of movement of fragments down the tube from an operational viewpoint. In addition, the reduction in frictional forces/drag reduces wear of the tube and breakdown of fragments due to contact with the tube. Hence, there is an increase in operational life of equipment and a decrease in dust generation.

The term “fragment” is understood herein to mean any suitable size of mined material having regard to materials handling and processing capabilities of the apparatus used to carry out the method and the downstream processing requirements. In the context of ore sorting, relevant factors include issues associated with detecting sufficient information to make an accurate assessment of the mined material in the fragment. It is also noted that the term “fragment” as used herein may be understood by some persons skilled in the art to be better described as “particles”. The intention is to use both terms as synonyms.

The term “applicator” is understood herein to mean a chamber for receiving and retaining electromagnetic radiation within the chamber.

The term “bed” is understood herein to mean that adjacent fragments in the bed are in contact with other.

In use, mined material is processed in the applicator on a bulk basis—as opposed to a fragment by fragment basis. More particularly, a feed mined material such as mined ore is supplied to the inlet of the applicator tube and moves as a bed of mined material, such as a packed bed in which the fragments are in contact with each other, through the applicator tube to the outlet end of the tube. The fragments are exposed to electromagnetic radiation in the applicator as the fragments move from the inlet to the outlet of the applicator tube.

The apparatus may include a source of electromagnetic radiation for the applicator.

The extent of the change in the cross-sectional area of the applicator tube that is required in any given situation is dependent on a number of factors including but not limited to a target throughput for the apparatus, the mineralogy and composition of the mined material, the size of the fragments including the fragment size distribution, the packing density in the bed, the power intensity and other characteristics of the electromagnetic radiation, and the exposure time required within the tube. Similarly, the selection of the width and the length of the applicator tube in any given situation are dependent on a range of factors including the above factors.

The extent of the change in cross-sectional area of the applicator tube may be up to 5% between the inlet and the outlet.

The extent of the change in cross-sectional area may be up to 10% between the inlet and the outlet.

The extent of the change in cross-sectional area may be up to 20% between the inlet and the outlet.

The extent of the change in cross-sectional area may be at least 2% between the inlet and the outlet.

The cross-sectional area of the applicator tube may increase continuously along the length of the tube between the inlet and the outlet of the tube.

The applicator tube may diverge or flare outwardly along the length of the tube between the inlet and the outlet.

The degree of divergence or flaring of the applicator tube may vary along the length of the tube.

The walls of the applicator tube may be straight when viewed in vertical cross-section.

The walls of the applicator tube may be curved when viewed in vertical cross-section.

The walls of the applicator tube may be any other suitable shape.

The applicator tube may include successive sections along the length of the tube between the inlet and the outlet, with each section having a range of cross-sectional areas that increase from an upper end to a lower end of the section, and each section defining a separate zone for exposing fragments in the zone to electromagnetic radiation.

With this arrangement, the apparatus may include an electromagnetic radiation source for each zone, with each electromagnetic radiation source being adapted to operate at a frequency that is selected on the basis of the range of the cross-sectional areas of the zone.

The applicator may include a choke separating each zone in the applicator tube to prevent electromagnetic radiation escaping from one zone into another zone.

The applicator tube may include at least one section of the length of the tube that has a uniform cross-sectional area.

The uniform cross-sectional area section of the applicator tube may be a first section of the tube extending from the inlet. The remainder of the length of the applicator tube may increase continuously to the outlet of the tube.

The uniform cross-sectional area section of the applicator tube may be a transition between two other sections of the tube that increase continuously along these sections.

The applicator tube may be a wear resistant tube.

The applicator tube may be formed from a wear resistant material.

The applicator tube may include an inner lining of a wear resistant material.

The term “wear resistant” is understood herein in the context of the mined material being processed in the apparatus.

The applicator tube may be arranged vertically.

The applicator tube may be an angle to the vertical.

The angle may be in a range of up to 30° from the vertical.

The applicator tube may be at least 80 mm wide at the inlet.

The applicator tube may be at least 150 mm wide at the inlet.

The applicator tube may be at least 200 mm wide at the inlet.

The applicator tube may be at least 500 mm wide at the inlet.

The applicator tube may be at least 250 mm long.

The applicator tube may be at least 1 m long.

The applicator tube may be at least 2 m long.

The applicator tube may be any suitable transverse profile. By way of example, the tube may have a circular transverse cross-section.

The applicator may include chokes upstream of the inlet and the downstream of the outlet for preventing electromagnetic radiation escaping from the applicator tube via the inlet and the outlet.

The choke downstream of the outlet of the applicator tube may be in the form of a rotary valve, such as a rotatable star wheel, for controlling discharge of material from the applicator tube.

The applicator may be adapted to operate on a continuous basis with mined material moving continuously through the applicator tube, for example in plug flow, and being exposed to electromagnetic radiation as it moves through the applicator.

The applicator may be adapted to operate with any suitable electromagnetic radiation. For example, the radiation may be X-ray, microwave and radio frequency radiation.

The electromagnetic radiation may be pulsed or continuous electromagnetic radiation.

The selection of exposure parameters, such as the type of radiation and the length of exposure and the energy of the radiation, in the applicator may be based on known information on the mined material and downstream processing options for the mined material.

When the applicator is adapted to operate with microwave radiation, the applicator tube may include angled waveguides for directing microwave radiation into the applicator tube.

The waveguides may be located at the Brewster angle in relation to a wall of the applicator tube.

The term “Brewster angle”, also known as the polarisation angle, is understood herein to mean an angle of incidence at which electromagnetic radiation with a particular polarisation is perfectly transmitted through a surface with no reflection.

By way of further example, when the applicator is adapted to operate with microwave radiation, the applicator may include a ring main positioned around the circumference of the applicator tube for supplying electromagnetic radiation to the applicator tube and a series of microwave radiation transparent windows or openings between the applicator tube and the ring main to allow microwave radiation to be transmitted from the ring main into the applicator tube.

In a situation where an applicator is adapted to operate with radio frequency radiation, the applicator may include a first electrode within the applicator tube and a second electrode outside or forming at least a part of the applicator tube or both electrodes outside the tube.

According to the present invention there is provided an apparatus for sorting mined material, such as mined ore, that includes:

(a) an applicator for exposing a downwardly moving bed of fragments of a material to electromagnetic radiation, the applicator including a tube for containing the moving bed of fragments that has an upper inlet and a lower outlet and a transverse cross-sectional area that increases between the inlet and the outlet,

(b) a detection and assessment system for detecting and assessing one or more than one characteristic of the fragments, and

(c) a sorting means in the form of a separator for separating the fragments into multiple streams in response to the assessment of the detection and assessment system.

The applicator may have the above-described features.

The apparatus may include a fragment distribution assembly for distributing fragments from the applicator so that the fragments move downwardly and outwardly from an upper inlet of the distribution assembly and are discharged from a lower outlet of the distribution assembly as individual, separate fragments that are not in contact with each other. The assembly may have an upper inlet and a lower outlet and a downwardly and outwardly extending distribution surface on which fragments are able to move from the upper inlet to the lower outlet and which allow fragments to be distributed into individual, separate fragments by the time the fragments reach the lower outlet. In use of this arrangement, fragments from the outlet of the applicator tube are supplied to the upper inlet of the fragment distribution assembly. The fragments move, for example by sliding and/or tumbling, down the distribution surface of the assembly. The fragments move downwardly and outwardly on the distribution surface from the upper inlet to the lower outlet of the assembly. The distribution surface allows the fragments to disperse into a distributed state in which the fragments are not in contact with other fragments and move as individual, separate fragments and are discharged from the assembly in this distributed state.

The distribution surface of the distribution assembly may be a conical surface or a segment of a conical surface that extends downwardly and outwardly.

The distribution surface may be an upper surface of a conical member or a segment of a conical member or an upper surface of a frusto-conical member or a segment of a frusto-conical member that are arranged to extend downwardly and outwardly.

The conical surface may define any suitable cone angle, i.e. any suitable angle to a horizontal axis.

The conical surface may define an angle of at least 30° to a horizontal axis.

The conical surface may define an angle of at least 45° to a horizontal axis.

The conical surface may define an angle of less than 75° to a horizontal axis.

The distribution surface of the distribution assembly may be an upper surface of an angled plate, such as an angled flat plate.

The distribution surface of the distribution assembly may be an upper surface of a pair of plates, such as a pair of flat plates or a pair of curved plates, that extend outwardly and downwardly away from each other.

The distribution assembly may include a chamber that is defined in part by the distribution surface.

The chamber may be a conical or a frusto-conical chamber.

The distribution assembly may be adapted to operate as a second electromagnetic radiation applicator for exposing fragments to electromagnetic radiation as the fragments move down the distribution surface. In that event, the apparatus may include a source of electromagnetic radiation for the chamber. In use of such an arrangement the mined material is exposed to electromagnetic radiation in two applicators, namely this chamber, which is a form of an applicator, and the upstream (in terms of the direction of movement of material) applicator.

The same or different exposure conditions may be used in the two applicators, depending on the requirements in any given situation. For example, the electromagnetic radiation in the upstream applicator may be selected to cause microfracturing of the fragments to break down the fragments into smaller sizes and the electromagnetic radiation in the downstream distribution assembly may be selected to facilitate sorting of the fragments. In this arrangement, the operating conditions in the upstream applicator may be selected, having regard to the characteristics of the mined material so that the fragments fracture to smaller fragments in the upstream applicator and/or as the fragments move through the downstream distribution assembly and/or in downstream processing steps, such as conventional comminution steps. By way of further example, the electromagnetic radiation in one applicator may be selected to allow detection and assessment of one characteristic and the other applicator may be selected to allow detection and assessment of another characteristic of the fragments.

The detection and assessment system may include a sensor for detecting the response, such as the thermal response, of each fragment to electromagnetic radiation.

The detection and assessment system may include a sensor for detecting other characteristics of the fragment. The sensor may include any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale. Each of these sensors is capable of providing information on the properties of the mined material in the fragments, for example as mentioned in the brackets following the names of the sensors.

The detection and assessment system may include a processor for analysing the data for each fragment, for example using an algorithm that takes into account the sensed data, and classifying the fragment for sorting and/or downstream processing of the fragment, such as heap leaching and smelting.

The assessment of the fragments may be on the basis of grade of a valuable metal in the fragments. The assessment of the fragments may be on the basis of another characteristic (which could also be described as a property), such as any one or more of hardness, texture, mineralogy, structural integrity, and porosity of the fragments. In general terms, the purpose of the assessment of the fragments is to facilitate sorting of the fragments and/or downstream processing of the fragments. Depending on the particular circumstances of a mine, particular combinations of properties may be more or less helpful in providing useful information for sorting of the fragments and/or downstream processing of the fragments.

The detection and assessment system may be adapted to generate control signals to selectively activate the separator in response to the fragment assessment.

The lower outlet of the distribution assembly may be adapted to discharge fragments as a downwardly-falling curtain of fragments. The curtain of material is a convenient form for high throughput analysis of fragments.

The separator for separating the fragments into multiple streams in response to the assessment of the detection and assessment system may be any suitable separator. By way of example, the separator may include a plurality of air jets that can be actuated selectively to displace fragments form a path of movement.

The apparatus may be adapted to sort mined material at any suitable throughput. The required throughput in any given situation is dependent on a range of factors including, but not limited to, operating requirements of upstream and downstream operations.

The apparatus may be adapted to sort at least 100 tonnes per hour of mined material.

The apparatus may be adapted to sort at least 250 tonnes per hour of mined material.

The apparatus may be adapted to sort at least 500 tonnes per hour of mined material.

The apparatus may be adapted to sort at least 1000 tonnes per hour of mined material.

The mined material may be any mined material that contains valuable material, such as valuable metals. Examples of valuable materials are valuable metals in minerals such as minerals that comprise metal oxides or metal sulphides. Specific examples of valuable materials that contain metal oxides are iron ores and nickel laterite ores. Specific examples of valuable materials that contain metal sulphides are copper-containing ores. Other examples of valuable materials are salt and coal.

Particular, although not exclusive, areas of interest to the applicant are mined material in the form of (a) ores that include copper-containing minerals such as chalcopyrite, in sulphide forms and (b) iron ore.

The present invention is particularly, although not exclusively, applicable to sorting low grade mined material.

The term “low” grade is understood herein to mean that the economic value of the valuable material, such as a metal, in the mined material is only marginally greater than the costs to mine and recover and transport the valuable material to a customer.

In any given situation, the concentrations that are regarded as “low” grade will depend on the economic value of the valuable material and the mining and other costs to recover the valuable material from the mined material at a particular point in time. The concentration of the valuable material may be relatively high and still be regarded as “low” grade. This is the case with iron ores.

In the case of valuable material in the form of copper sulphide minerals, currently “low” grade ores are run-of-mine ores containing less than 1.0% by weight, typically less than 0.6 wt. %, copper in the ores. Sorting ores having such low concentrations of copper from barren fragments is a challenging task from a technical viewpoint, particularly in situations where there is a need to sort very large amounts of ore, typically at least 10,000 tonnes per hour, and where the barren fragments represent a smaller proportion of the ore than, the ore that contains economically recoverable copper.

The term “barren” fragments, when used in the context of copper-containing ores, is understood herein to mean fragments with no copper or very small amounts of copper that can not be recovered economically from the fragments.

The term “barren” fragments when used in a more general sense in the context of valuable materials is understood herein to mean fragments with no valuable material or amounts of valuable material that can not be recovered economically from the fragments.

According to the present invention there is provided an applicator for exposing a downwardly moving bed of fragments of a material to electromagnetic radiation, the applicator being in the form of a tube for containing the moving bed of fragments that has an upper inlet and an lower outlet and a transverse cross-sectional area that increases between the inlet and the outlet.

According to the present invention there is provided a method of processing mined material, such as mined ore, including moving a bed of fragments of mined material downwardly through the above-described electromagnetic radiation applicator and exposing the fragments to electromagnetic radiation as the fragments move through the applicator.

The method may include moving the fragments downwardly through the electromagnetic radiation applicator via a gravity feed.

The method may include moving the fragments downwardly through the electromagnetic radiation applicator via a forced feed.

The method may include moving the fragments downwardly through the applicator at a speed of at least 0.5 m/s.

The method may include moving the fragments downwardly through the applicator at a speed of at least 0.6 m/s.

The method may include sorting mined material at a throughput of at least 100 tonnes per hour.

The method may include sorting mined material at a throughput of at least 250 tonnes per hour.

The method may include sorting mined material at a throughput of at least 500 tonnes per hour.

The method may include sorting mined material at a throughput of at least 1000 tonnes per hour.

According to the present invention there is provided a method of sorting mined material, such as mined ore, including the steps of:

(a) moving a bed of fragments of mined material downwardly through the above-described electromagnetic radiation applicator and exposing the fragments to electromagnetic radiation as the fragments move through the applicator,

(b) detecting one or more than one characteristic of the fragments,

(c) assessing the characteristic(s) of the fragments, and

(d) sorting the fragments into multiple streams in response to the assessment of the characteristic(s) of the fragments.

The method may include supplying the fragments that have been exposed to electromagnetic radiation to a distribution assembly and allowing the fragments to move downwardly and outwardly over a distribution surface of the assembly from an upper inlet to a lower outlet so that the fragments are distributed into individual, separate fragments and are discharged from the assembly as individual, separate fragments.

The method may include exposing the fragments to electromagnetic radiation as the fragments move downwardly and outwardly over the distribution surface of the distribution assembly.

Method step (a) may be as described above in relation to the more general method of processing mined material.

Detection step (b) may include detecting the response, such as the thermal response, of each fragment to exposure to electromagnetic radiation.

Assessment step (c) may include analysing the response of each fragment to identify valuable material in the fragment.

Detection step (b) is not confined to sensing the response of fragments of the mined material to electromagnetic radiation and extends to sensing additional characteristics of the fragments. For example, step (b) may also extend to the use of any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale. Each of these sensors is capable of providing information on the properties of the mined material in the fragments, for example as mentioned in the brackets following the names of the sensors.

The method may include a downstream processing step of comminuting the sorted material as a pre-treatment step for a downstream option for recovering the valuable mineral from the mined material.

The method may include a downstream processing step of blending the sorted material as a pre-treatment step for a downstream option for recovering the valuable mineral from the mined material.

The method may include using the sensed data for each fragment as feed-forward information for downstream processing options, such as flotation and comminution, and as feed-back information to upstream mining and processing options.

The upstream mining and processing options may include drill and blast operations, the location of mining operations, and crushing operations.

According to the present invention there is also provided a method for recovering valuable material, such as a valuable metal, from mined material, such as mined ore, that includes processing mined material according to the method described above and thereafter further processing the fragments containing valuable material and recovering valuable material.

The further processing options for the fragments may be any suitable options, such as smelting and leaching options.

### BRIEF DESCRIPTION OF THE DRAWINGS

The present invention is described further by way of example with reference to the accompanying drawings of which:

FIG. 1 illustrates diagrammatically a vertical cross-section of key components of one embodiment of a sorting apparatus in accordance with the present invention, which includes one embodiment of an electromagnetic radiation applicator in accordance with the present invention;

FIG. 2 is a vertical cross-section through the tube of the electromagnetic radiation applicator shown in FIG. 1 without the packed bed of fragments in the tube to provide a clearer view of the tube; and

FIG. 3 is a vertical cross-section through the tube of another embodiment of an electromagnetic radiation applicator of the present invention without a packed bed of fragments in the tube to provide a clearer view of the tube;

FIG. 4 is a vertical cross-section through the tube of another (although not the only possible other) embodiment of an electromagnetic radiation applicator of the present invention without a packed bed of fragments in the tube to provide a clearer view of the tube; and

FIG. 5 is a perspective view of another embodiment of an apparatus for processing mined material in accordance with the present invention, with this embodiment being concerned with microfracturing fragments of mined material rather than sorting mined material as is the case with the FIG. 1 embodiment.

### DESCRIPTION OF EMBODIMENTS

The embodiments are described in the context of the use of microwave energy as the electromagnetic radiation. However, it is noted that the invention is not confined to the use of microwave energy and extends to the use of other types of electromagnetic radiation, such as radio frequency radiation and x-ray radiation.

The embodiments of the method of processing mined material shown in FIGS. 1 to 4 are described as a method of sorting mined material. More particularly, the embodiments are described in the context of a method and an apparatus for recovering a valuable metal in the form of copper from a low grade copper-containing ore in which the copper is present in copper-containing minerals such as chalcopyrite and the ore also contains non-valuable gangue. The objective of the method in these embodiments is to identify fragments of mined material containing amounts of copper-containing minerals above a certain grade and to sort these fragments from the other fragments and to process the copper-containing fragments as required to recover copper from the fragments.

It is noted that, whilst the following description does not focus on the downstream processing options, these options are any suitable options ranging from smelting to leaching the fragments.

It is also noted that whilst the following description focuses on sorting mined material, the invention also extends to other processing options for mined material, such as microfracturing fragments of mined material.

It is also noted that the present invention is not confined to copper-containing ores and to copper as the valuable material to be recovered. In general terms, the present invention provides a method of sorting any minerals which exhibit different heating responses, when exposed to electromagnetic radiation.

With reference to FIG. 1, a feed material in the form of fragments of copper-containing ore that have been crushed by a primary crusher (not shown) to a fragment size, of 10-25 cm is supplied under gravity feed via a vertical transfer hopper 3 (or other suitable transfer means, such as a conveyor belt supplying material to a feed hopper) to a microwave radiation applicator generally identified by the numeral 2.

The applicator 2 comprises a vertical chute or tube 4. The ore is exposed to microwave radiation on a bulk basis as the fragments move downwardly in a bed, preferably a packed bed in which the fragments are in contact moving in plug flow, through the tube 4 from an upper inlet 6 to a lower outlet 8 of the tube 4. The tube 4 has a circular transverse cross-sectional area that increases from the inlet 6 to the outlet 8. The extent of the change in cross-sectional area is at least 2% from the inlet 6 to the outlet 8. The extent of the change in the cross-sectional area required in any given situation is dependent on a number of factors including but not limited to a target throughput for the apparatus, the mineralogy and composition of the mined material, the size of the fragments including the fragment size distribution, the packing density in the bed, the power intensity and other characteristics of the microwave radiation, and the exposure time required within the tube 4. Similarly, the selection of the width and the length of the tube 4 in any given situation are dependent on a range of factors including the above factors.

The cross-sectional area of the tube 4 increases continuously along the length of the tube 4 from the inlet 6 to the outlet 8 of the tube 4. More specifically, with reference to FIG. 2, in the FIG. 1 embodiment the tube 4 has a straight wall that diverges outwardly along the length of the tube from the inlet 6 to the outlet 8 when viewed in vertical cross-section.

With reference to FIG. 1, chokes 14, 16 for preventing microwave radiation escaping from the tube 4 are positioned upstream of the inlet 6 and downstream of the outlet 8 of the tube 4. The chokes 14, 16 are in the form of rotary valves in the form of rotatable star wheels in this instance (as shown diagrammatically in the Figure) that control supply and discharge of ore into and from the tube 4.

The applicator 2 also comprises a source of microwave radiation (not shown) and a pair of opposed waveguides 18 for directing microwave radiation into the tube 4. The waveguides 18 are located at the Brewster angle with respect to the wall of the tube 4. It is noted that the waveguides 18 are one of a number of options for introducing microwave radiation into the tube 4. One other, although not the only other, option is to introduce the microwave radiation via a ring main positioned around the circumference of the tube 4, with a series of microwave transparent windows or openings in the tube 4 and the ring main that allow microwave radiation to be transmitted into the tube 4. The size and the number of the openings are selected to provide a homogeneous, i.e. uniform, field in the tube 4.

The outlet 8 of the tube 4 is aligned vertically with an inlet of a fragment distribution assembly. The distribution assembly is generally identified by the numeral 7. The outlet 8 supplies fragments that have been exposed to electromagnetic radiation in the tube 4 directly to the distribution assembly 7.

The distribution assembly 7 includes a distribution surface 11 for the fragments. The fragments move downwardly and outwardly over the distribution surface 11, typically in a sliding and/or a tumbling motion, from an upper central inlet 23 of the distribution assembly 7 to a lower annular outlet 25 of the assembly 7. The distribution surface 11 allows the fragments to disperse from the packed bed state in which the fragments are in contact with each other in the tube 4 to a distributed state in which the fragments are not in contact with other fragments and move as individual, separate fragments and are discharged from the outlet 25 as individual, separate fragments.

The distribution assembly 7 comprises an inner wall having a conical surface that forms the distribution surface 11. The conical surface is an upper surface of a conical-shaped member.

The distribution surface 11 is shrouded by an outer wall having a second concentric outer conical surface 15. The distribution assembly 7 also includes chokes 31, 33 in the upper inlet 23 and the lower outlet 25 of the assembly 7. As a consequence, if required from an operational viewpoint, the assembly 7 may function as a second applicator for further exposing the fragments to electromagnetic radiation. The electromagnetic radiation may be microwave radiation or any other suitable type of radiation. Depending on the circumstances, the apparatus may include another source of electromagnetic radiation in addition to that forming part of the applicator 2. In this context, this configuration of the apparatus has a particular advantage in the case of electromagnetic radiation in the radio frequency band. When operating with radio frequency radiation, the distribution surface 11 and the outer conical surface 15 are electrically isolated and configured to form parallel electrodes of a radio frequency applicator. These electrodes are identified by the numerals 27, 29 in FIG. 1.

The fragments are detected and assessed by a detection and assessment system as they move through the distribution assembly 7.

More specifically, while passing through the distribution assembly 7, radiation, more particularly heat radiation, from the fragments as a consequence of (a) exposure to microwave energy at the applicator 2 and optionally in the distribution assembly 7 and (b) the characteristics (such as composition and texture) of the fragments is detected by thermal imagers in the form of high resolution, high speed infrared imagers (not shown) which capture thermal images of the fragments. While one thermal imager is sufficient, two or more thermal imagers may be used for full coverage of the fragment surface. It is noted that the present invention is not limited to the use of such high resolution, high speed infrared imagers. It is also noted that the present invention is not limited to detecting the thermal response of fragments to microwave energy and extends to detecting other types of response.

From the number of detected hot spots (pixels), temperature, pattern of their distribution and their cumulative area, relative to the size of the fragments, an estimation of the grade of the fragments can be made. This estimation may be supported and/or more mineral content may be quantified by comparison of the data with previously established relationships between microwave induced thermal properties of specifically graded and sized fragments.

In addition, one or more optical sensors, for example in the form of visible light cameras (not shown) capture visible light images of the fragments to allow determination of fragment size.

The present invention also extends to the use of other sensors for detecting other characteristics of the fragments, such as texture.

Images collected by the thermal imagers and the visible light cameras (and information from other sensors that may be used) are processed in the detection and assessment system by a computer (indicated in the figure by the word “Control System”) equipped with image processing and other relevant software. The software is designed to process the sensed data to assess the fragments for sorting and/or downstream processing options. In any given situation, the software may be designed to weight different data depending on the relative importance of the properties associated with the data.

The detection and assessment system generates control signals to selectively activate a sorting means in response to the fragment assessment.

More specifically, the fragments free-fall from the outlet 25 of the distribution assembly 7 and are separated into annular collection bins 17, 19 by a sorting means that comprises compressed air jets (or other suitable fluid jets, such as water jets, or any suitable mechanical devices, such as mechanical flippers) that selectively deflect the fragments as the fragments move in a free-fall trajectory from the outlet 25 of the distribution assembly 7. The air jet nozzles are identified by the numeral 13. The air jets selectively deflect the fragments into two circular curtains of fragments that free-fall into the collection bins 17, 19. The thermal analysis identifies the position of each of the fragments and the air jets are activated a pre-set time after a fragment is analysed as a fragment to be deflected.

The positions of the thermal imagers and the other sensors and the computer and the air jets may be selected as required. In this connection, it is acknowledged that the figure is not intended to be other than a general diagram of one embodiment of the invention.

The microwave radiation may be either in the form of continuous or pulsed radiation. The microwave radiation may be applied at an electric field below that which is required to induce micro-fractures in the fragments. In any event, the microwave frequency and microwave intensity and the fragment exposure time and the other operating parameters of the applicator 2 are selected having regard to the information that is required. The required information is information that is required to assess the particular mined material for sorting and/or downstream processing of the fragments. In any given situation, there will be particular combinations of characteristics, such as grade, mineralogy, hardness, texture, structural integrity, and porosity, that will provide the necessary information to make an informed decision about the sorting and/or downstream processing of the fragments, for example, the sorting criteria to suit a particular downstream processing option.

As noted above, there may be a range of other sensors (not shown) other than thermal imagers and visible light cameras mentioned above positioned within and/or downstream of the applicator 2 and the distribution assembly 7 to detect other characteristics of the fragments depending on the required information to classify the fragments for sorting and/or downstream processing options.

In one mode of operation the thermal analysis is based on distinguishing between fragments that are above and below a threshold temperature. The fragments can then be categorised as “hotter” and “colder” fragments. The temperature of a fragment is related to the amount of copper minerals in the fragment. Hence, fragments that have a given size range and are heated under given conditions will have a temperature increase to a temperature above a threshold temperature “x” degrees if the fragments contain at least “y” wt. % copper. The threshold temperature can be selected initially based on economic factors and adjusted as those factors change. Barren fragments will generally not be heated on exposure to radio frequency radiation to temperatures above the threshold temperature.

In the present instance, the primary classification criteria is the grade of the copper in the fragment, with fragments above a threshold grade being separated into collection bin 19 and fragments below the threshold grade being separated into the collection bin 17. The valuable fragments in bin 19 are then processed to recover copper from the fragments. For example, the valuable fragments in the bin 19 are transferred for downstream processing including milling and flotation to form a concentrate and then processing the concentrate to recover copper.

The fragments in collection bin 17 may become a by-product waste stream and are disposed of in a suitable manner. This may not always be the case. The fragments have lower concentrations of copper minerals and may be sufficiently valuable for recovery. In that event the colder fragments may be transferred to a suitable recovery process, such as leaching.

In the case of the embodiment shown in FIG. 3, the wall of the tube 4 is curved when viewed in vertical cross-section.

In the case of the embodiment shown in FIG. 4, the tube includes successive sections 4a and 4b along the length of the tube 4 from the inlet 6 to the outlet 8, with each section having a range of cross-sectional areas that increase from an upper end to a lower end of the section, and each section defines a separate zone A, B for exposing fragments in the zone to electromagnetic radiation. In this embodiment, the apparatus includes an electromagnetic radiation source (not shown) for each zone A, B, with each electromagnetic radiation source being adapted to operate at a frequency that is selected on the basis of the range of the cross-sectional areas of the zone. In addition, in this embodiment the tube 4 includes a choke 26 between the two zones A, B that prevents microwave radiation escaping from one zone into the other zone.

Advantages of the present invention include the following advantages.
Processing ore fragments in bulk form in the applicator 2 has been found to dramatically improve the efficiency of energy delivery compared to a horizontal belt arrangement with a mono-layer of mined material.
Providing the applicator tube with a transverse cross-sectional area that increases from the inlet to the outlet of the tube reduces friction between the moving bed of fragments and the tube and outward pressure applied by the moving bed to the tube. The overall result is that there is a reduction in frictional forces/drag and hence a greater likelihood of promoting plug flow, i.e. uniform movement of fragments down the tube across the transverse cross-section of the tube. In addition, the reduction in frictional forces/drag reduces wear of the tube and breakdown of fragments due to contact with the tube and thereby a reduction in dust generation.

FIG. 3 is a perspective view of another, although not the only other possible, embodiment of an apparatus for processing mined material in accordance with the present invention, with this embodiment being concerned with microfracturing fragments of mined material to facilitate downstream processing of the fragments. The downstream processing may include comminuting the fragments and forming smaller fragments, processing the smaller fragments in a flotation circuit and forming a concentrate and smelting the concentrate to recovery valuable metals. Another downstream processing option includes heap leaching, with the microfractures allowing leach liquor to penetrate the fragments and improve recovery of valuable metals.

With reference to FIG. 3, a feed material in the form of fragments of copper-containing ore that have been crushed by a primary crusher (not shown) to a fragment size of 10-25 cm is supplied via a horizontal conveyor assembly 24 to a vertical transfer hopper 3 and then downwardly under gravity feed to a microwave radiation applicator assembly generally identified by the numeral 2. The applicator assembly 2 includes a vertical cylindrical tube 4 and a microwave radiation applicator 12 positioned along the length of the assembly 2. The ore is exposed to microwave radiation on a bulk basis as the fragments move downwardly in a bed, preferably a packed bed, through the tube 4 from an upper inlet 6 to a lower outlet 8 of the tube 4. Chokes 14, 16 for preventing microwave radiation escaping from the tube 4 are positioned upstream of the inlet 6 and downstream of the outlet 8 of the tube 4. The chokes 14, 16 are in the form of rotary valves that also control supply and discharge of ore into and from the tube 4. The ore discharged from the lower outlet 8 of the tube 4 is transferred onto a conveyor 26 or other suitable transfer option for downstream processing.

As is the case with the embodiment described in relation to FIGS. 1 and 2, the cross-sectional area of the tube 4 increases continuously along the length of the tube 4 from the inlet 6 to the outlet 8 of the tube 4.

Many modifications may be made to the embodiment of the present invention described above without departing from the spirit and scope of the present invention.

By way of example, the present invention is not limited to a fragment by fragment detection and assessment and sorting of mined material and extends to bulk assessment and detection and sorting of mined material.

In addition, in situations where there is fragment by fragment detection and assessment and sorting of mined material, the present invention is not limited to the particular fragment distribution assembly 7 shown in FIG. 1.

In addition, the present invention is not limited to the 3 embodiments of the applicator tube shown in FIGS. 2-4 and extends to any arrangements that have a transverse cross-sectional area that increases between the inlet and the outlet of the tube.

1-2. (canceled)

3. The apparatus defined in claim 23 wherein the extent of the change in cross-sectional area of the applicator tube is up to 5% between the inlet and the outlet.

4. The apparatus defined in claim 3 wherein the extent of the change in cross-sectional area is up to 10% between the inlet and the outlet.

5. The apparatus defined in claim 23 wherein the extent of the change in cross-sectional area of the applicator tube is at least 2% between the inlet and the outlet.

6. The apparatus defined in claim 23 wherein the cross-sectional area of the applicator tube increases continuously along the length of the tube between the inlet and the outlet end of the tube.

7. The apparatus defined in claim 23 wherein the applicator tube diverges or flares outwardly along the length of the tube between the inlet and the outlet.

8. The apparatus defined in claim 23 wherein the applicator tube has walls that are straight when viewed in vertical cross-section.

9. The apparatus defined in claim 23 wherein the applicator tube has walls that are curved when viewed in vertical cross-section.

10. The apparatus defined in claim 23 wherein the applicator tube includes successive sections along the length of the tube between the inlet and the outlet, with each section having a range of cross-sectional areas that increase from an upper end to a lower end of the section, and each section defining a separate zone for exposing fragments in the zone to electromagnetic radiation.

11. The apparatus defined in claim 10 includes an electromagnetic radiation source for each zone, with each electromagnetic radiation source being adapted to operate at a frequency that is selected on the basis of the range of the cross-sectional areas of the zone.

12. The apparatus defined in claim 10 wherein the applicator includes a choke separating each zone in the applicator tube to prevent electromagnetic radiation escaping from one zone into another zone.

13. The apparatus defined in claim 23 wherein the applicator tube extends vertically.

14. The apparatus defined in claim 23 wherein the applicator tube extends at an angle in a range of up to 30° from the vertical.

15. The apparatus defined in claim 23 wherein the applicator tube is at least 80 mm wide at the inlet.

16. The apparatus defined in claim 15 wherein the applicator tube is at least 150 mm wide at the inlet.

17. The apparatus defined in claim 23 wherein the applicator tube is at least 500 mm wide at the inlet.

18. The apparatus defined in claim 23 wherein the applicator tube is at least 250 mm long.

19. The apparatus defined in claim 18 wherein the applicator tube is at least 1 m long.

20. The apparatus defined in claim 23 wherein the applicator tube has a circular transverse cross-section.

21. The apparatus defined in claim 23 includes chokes upstream of the inlet and the downstream of the outlet of the applicator tube for preventing electromagnetic radiation escaping from the applicator tube via the inlet and the outlet.

22. The apparatus defined in claim 23 wherein the applicator is adapted to operate on a continuous basis with mined material moving continuously through the applicator tube and being exposed to electromagnetic radiation as it moves through the applicator tube.

23. An apparatus for sorting mined material includes:
(a) an applicator for exposing a downwardly moving bed of fragments of a material to electromagnetic radiation, the applicator including a tube for containing the moving bed of fragments that has an upper inlet and a lower outlet and a transverse cross-sectional area that increases between the inlet and the outlet,
(b) a detection and assessment system for detecting and assessing one or more than one characteristic of the fragments, and
(c) a sorting means in the form of a separator for separating the fragments into multiple streams in response to the assessment of the detection and assessment system.

24. The apparatus defined in claim 23 includes a fragment distribution assembly for distributing fragments from the applicator so that the fragments move downwardly and outwardly from an upper inlet of the distribution assembly and are discharged from a lower outlet of the distribution assembly as individual, separate fragments that are not in contact with each other.

25. The apparatus defined in claim 24 wherein the fragment distribution assembly has an upper inlet and a lower outlet and a downwardly and outwardly extending distribution surface on which fragments are able to move from the upper inlet to the lower outlet and which allows fragments to be distributed into individual, separate fragments by the time the fragments reach the lower outlet.

26. The apparatus defined in claim 25 wherein the distribution surface of the fragment distribution assembly includes a conical surface or a segment of a conical surface that extends downwardly and outwardly.

27. The apparatus defined in claim 23 wherein the detection and assessment system includes a sensor for detecting the response, such as the thermal response, of each fragment to electromagnetic radiation.

28. The apparatus defined in claim 27 wherein the detection and assessment system include a sensor or sensors for detecting other characteristics of the fragment.

29. The apparatus defined in claim 23 wherein the detection and assessment system includes a processor for analysing the data for each fragment, for example using an algorithm that takes into account the sensed data, and classifying the fragment for sorting and/or downstream processing of the fragment, such as heap leaching and smelting.

30. The apparatus defined in claim 23 wherein the detection and assessment system is adapted to generate control signals to selectively activate the separator in response to the fragment assessment.

31. (canceled)

32. A method of processing mined material including moving a bed of fragments of mined material downwardly through an applicator for exposing a downwardly moving bed of fragments of a material to electromagnetic radiation and exposing the fragments to electromagnetic radiation as the fragments move through the applicator, the applicator including a tube for containing the moving bed of fragments that has an upper inlet and a lower outlet and a transverse cross-sectional area that increases between the inlet and the outlet.

33. The method defined in claim 32 wherein step (a) includes moving the fragments downwardly through the applicator at a speed of at least 0.5 m/s.

34. The method defined in claim 32 includes sorting mined material at a throughput of at least 250 tonnes per hour.

35. A method of sorting mined material including the steps of:
(a) moving a bed of fragments of mined material downwardly through an applicator for exposing a downwardly moving bed of fragments of a material to electromagnetic radiation and exposing the fragments to electromagnetic radiation as the fragments move through the applicator, the applicator including a tube for containing the moving bed of fragments that has an upper inlet and a lower outlet and a transverse cross-sectional area that increases between the inlet and the outlet,
(b) detecting one or more than one characteristic of the fragments,
(c) assessing the characteristic(s) of the fragments, and
(d) sorting the fragments into multiple streams in response to the assessment of the characteristic(s) of the fragments.

36. The method defined in claim 35 includes supplying the fragments that have been exposed to electromagnetic radiation to a distribution assembly and allowing the fragments to move downwardly and outwardly over a distribution surface of the assembly from an upper inlet to a lower outlet so that the fragments are distributed into individual, separate fragments and are discharged from the assembly as individual, separate fragments.

37. A method for recovering valuable material, such as a valuable metal, from mined material, such as mined ore, that includes processing mined material according to the method defined in claim 32 and thereafter further processing the fragments containing valuable material and recovering valuable material.
